(19) United States
(12) Patent Application Publication
(10) Pub. No.: US 2011/0156604 A1
(43) Pub. Date: Jun. 30, 2011

(54) DRIVING CIRCUIT OF LIGHT EMITTING DIODE

(75) Inventors: Chun-Ting Kuo, Pingtung County (TW); Chun-Fu Lin, Taoyuan County (TW); Cheng-Han Hsieh, Hsinchu County (TW)

(73) Assignee: MY-SEMI INC., Hsinchu County (TW)

(21) Appl. No.: 12/975,362

(22) Filed: Dec. 22, 2010

(30) Foreign Application Priority Data
Dec. 31, 2009 (TW) 98146199

(51) Int. Cl. H05B 37/02; H05B 41/24; H05B 37/00

(52) U.S. Cl. 315/185 R; 315/294; 315/250

(57) ABSTRACT

A driving circuit of a light emitting diode (LED) is provided, including a driving unit, a current pre-charging unit and a feedback selecting unit. The driving unit outputs a driving power to drive the LEDs and outputs at least a first feedback signal according to the current conducted by the LEDs. The current pre-charging unit is coupled to an output of the driving unit to provide a current path to the driving unit and generates a second feedback signal according to a current conducted by the current pre-charging unit. The feedback selecting unit selects and outputs one of first feedback signals or the second feedback signal according to an enable signal, and the driving unit adjusts the driving power according to an output of the feedback selecting unit so as to maintain a current driving capability of the driving circuit to provide a sufficient current to drive the LEDs.

### CROSS-REFERENCE TO RELATED APPLICATION

This application claims the priority benefit of Taiwan application serial no. 98146199, filed on Dec. 31, 2009. The entirety of the above-mentioned patent application is hereby incorporated by reference herein and made a part of this specification.

### BACKGROUND OF THE INVENTION

1. Field of the Invention

The invention generally relates to a driving circuit of a light emitting diode (LED), and more specifically, to a driving circuit for maintaining a current driving ability.

2. Description of Related Art

As concerns for environmental and energy preservation have drastically increased, the light emitting diode (LED), owing to its small size, energy efficiency, and durability has gradually overtaken traditional incandescent light sources as the light source of the new millennium. The LED emits light by converting electrical energy into light energy. Since an LED chip is made of semiconductor materials, the emitted wavelength may be determined by the energy gap levels of the materials used, hence the LED can emit different colors of light. Therefore, not only can the LED be used as a white light source, it may also be adopted as automobile headlights, traffic signals, text displays, billboards and other large displays, as well as regular and architectural lighting and backlights for a liquid crystal display (LCD), etc.

Since the emitted brightness of the LED is related with the size of the current conducted, therefore while driving the LED, the driving capability of the current is emphasized. Especially for large LED billboards, since the purpose is to display images or texts, the response time of the LED is of great importance. In large LED billboards, due to the large number of LEDs, a significant magnitude of current is needed for driving the billboards. If a driving circuit cannot provide enough current in time, then the LED may not be able to display accurate brightness and image quality. Therefore, for an LED display or billboard, a current driving ability of an LED driving circuit becomes a matter of great importance. However, conventional LED driving circuits mainly focus on current stability or driving voltage control, but few have placed emphasis on improving the driving ability of the driving current.

### SUMMARY OF THE INVENTION

The present invention provides a driving circuit of a light emitting diode (LED) and a driving method thereof. A current pre-charging unit is disposed in the driving circuit, so as to maintain a current driving capability of the driving circuit to provide a sufficient current to drive the LED when the LED is being switched. Accordingly, a switching speed of the LED is accelerated, thereby preventing an issue of insufficient current affecting a display speed of the LED.

In light of the foregoing, an aspect of the invention provides a driving circuit adapted to drive at least an LED unit, in which the LED unit includes at least an LED. The driving circuit includes a driving unit, a current pre-charging unit, and a feedback selecting unit. The driving unit outputs a driving power to the LED unit, and outputs at least a first feedback signal according to a current conducted by the LED unit. The current pre-charging unit is coupled to an output of the driving unit to provide a current path to the driving unit, and the current pre-charging unit generates a second feedback signal according to the driving power. The feedback selecting unit is coupled to the driving unit and the current pre-charging unit, and according to an enable signal, the feedback selecting unit selects one of the first feedback signals or the second feedback signal FS as an output. The driving unit adjusts the driving power according to the output of the feedback selecting unit.

In one embodiment of the invention, when the enable signal is disabled and the LED unit is turned off, the feedback selecting unit selects the second feedback signal as the output, so that an output current of the driving unit is maintained at a predetermined value. When the enable signal is enabled and the LED unit is turned on, the feedback selecting unit selects as the output one of the enabled first feedback signals having a smallest voltage.

In one embodiment of the invention, the pre-charging unit includes a first resistor, a second resistor, an inverter, and a switch. The first resistor and the second resistor are serially coupled between the output of the driving unit and the switch. The inverter has an input end coupled to the enable signal and an output end coupled to the switch. When the enable signal is disabled, the switch is turned on, and when the enable signal is enabled, the switch is turned off.

In one embodiment of the invention, the above-described current pre-charging unit includes a first resistor, an adjustable current source, a control unit, and a delay unit. An end of the first resistor is coupled to the output of the driving unit, and the adjustable current source is coupled between another end of the first resistor and the ground. The control unit is coupled to the adjustable current source, and according to an original enable signal, the control unit adjusts a conducted current of the adjustable current source. The delay unit is coupled between the feedback selecting unit, the current controlling circuit, and the original enable signal. The delay unit is configured to delay the original enable signal a predetermined time so as to output the enable signal to the feedback selecting unit and the current controlling circuit. A node between the adjustable current source and the first resistor outputs the second feedback signal. During the predetermined time delay, the control unit changes the conducted current of the adjustable current source in accordance with the original enable signal, so as to increase an output current of the driving unit. Moreover, when the LEDs are turned on (i.e., after the predetermined time delay), the current of the adjustable current source is automatically turned off.

Another aspect of the invention provides a driving method of an LED, including the following steps. A driving power is outputted to drive an LED unit and generate at least a first feedback signal. Moreover, a current path is provided to the driving power, and a second feedback signal is generated according to a current conducted by the current path. According to an enable sign, whether to turn on the LEDs is determined. When the LED unit is turned off, the driving power is adjusted according to the second feedback signal. When the LED unit is turned on, the driving power is adjusted according to the first feedback signals. Please refer to the foregoing description of the driving circuit for the remaining operating details of the driving method. Hence, a detailed description thereof is omitted.

In summary, according to the invention as embodied and broadly described herein, a current driving capability of the driving circuit is maintained by an advance adjustment to a current, so that a sufficient current may be provided to an LED when the LED is being switched, and thereby accelerating a turn on time of the LED. Moreover, an embodiment of the invention uses the current pre-charging unit to provide feedback signals, so that even when the LED is turned off, the driving circuit may adjust the output of the power converting unit according to the feedback signals.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic block diagram of a driving circuit in accordance with a first embodiment of the invention.

FIG. 1B is a circuit diagram of a driving unit 105 in accordance with the first embodiment of the invention.

FIG. 2A is a detailed circuit diagram of a driving circuit in accordance with the first embodiment of the invention.

FIG. 2B is a circuit diagram of a driving circuit in accordance with the first embodiment of the invention.

FIG. 3A is a circuit diagram of a driving circuit in accordance with a second embodiment of the invention.

FIG. 3B is a circuit diagram of a driving circuit in accordance with the second embodiment of the invention.

FIG. 3C is a circuit diagram of a driving circuit in accordance with a third embodiment of the invention.

FIG. 4 illustrates a plurality of circuit structures of a current controlling circuit in accordance with an embodiment of the invention.

FIG. 5 illustrates a plurality of circuit structures of a current pre-charging circuit in accordance with an embodiment of the invention.

FIG. 6 is a flow chart of an LED driving method in accordance with a fourth embodiment of the invention.

### DESCRIPTION OF EMBODIMENTS

### First Embodiment

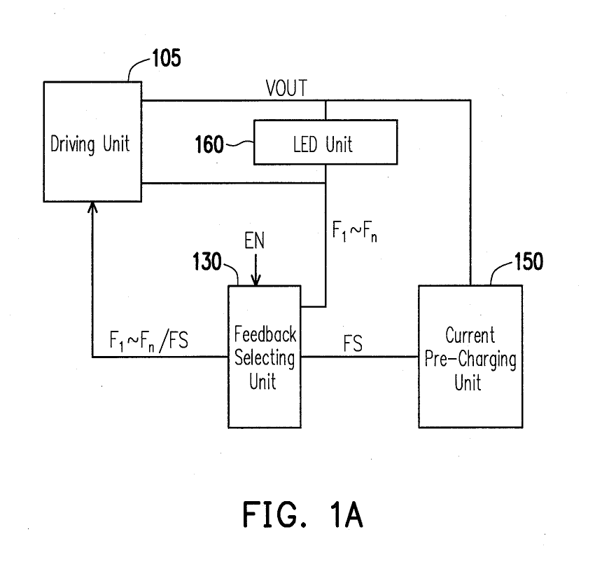

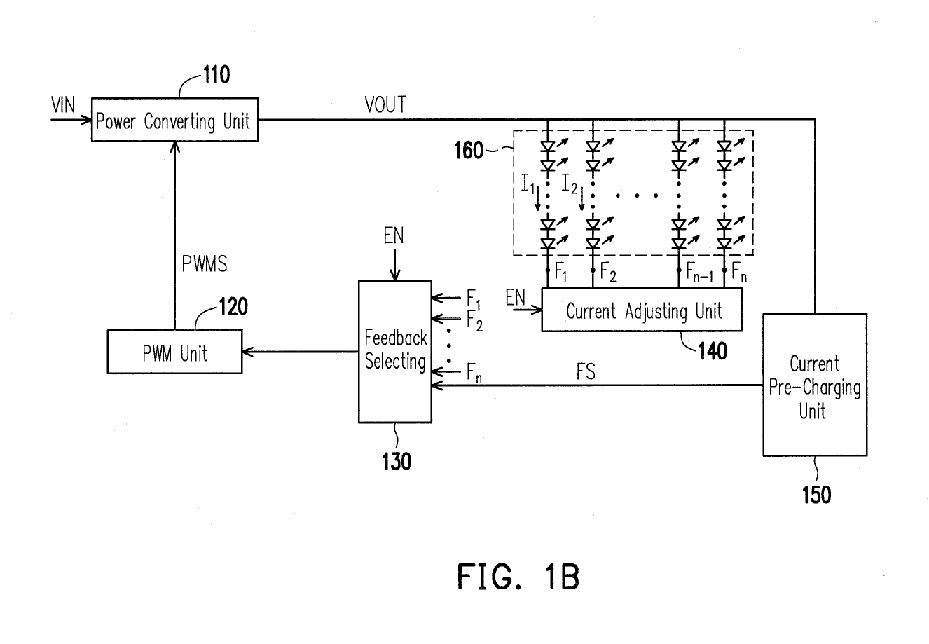

Referring to FIG. 1A, FIG. 1A is a schematic block diagram of a driving circuit in accordance with a first embodiment of the invention. The driving circuit is adapted to drive at least a light emitting diode (LED), and the driving circuit includes a driving unit 105, a feedback selecting unit 130, and a current pre-charging unit 150. The driving unit 105 is coupled to an LED unit 160, and the LED unit 160 includes at least an LED. The LEDs may form an LED string by mutually connecting in series. The driving unit 105 outputs a driving power VOUT to the LED unit 160, and outputs at least a first feedback signal F₁-Fₙ according to a current conducted by the LED string (not shown). The current conducted by the LED string can be derived by the first feedback signals F₁-Fₙ corresponding to the divided voltage of each LED string. The current pre-charging unit 150 is coupled to an output of the driving unit 105 to provide a current path to the driving unit 105. Moreover, the current pre-charging unit 150 generates a second feedback signal FS according to a current conducted by the current pre-charging unit 150, or a voltage level of the driving power VOUT. The feedback selecting unit 130 is coupled to the driving unit 105 and the current pre-charging unit 150. The feedback selecting unit 130 selects the first feedback signals F₁-Fₙ or the second feedback signal FS according to an enable signal EN. The driving unit 105 adjusts the driving power VOUT according to an output of the feedback selecting unit 130.

When the LED string in the LED unit 160 is turned on, the feedback selecting unit 130 selects one of the first feedback signals F₁-Fₙ as the output (e.g., a feedback signal having a lowest voltage), and the driving unit 105 adjusts the driving power VOUT according to the first feedback signals F₁-Fₙ. At this time, the operation of the entire driving circuit is similar to a conventional LED driving circuit, in that a feedback signal of an LED device is used to adjust the driving voltage VOUT. Generally speaking, the first feedback signals F₁-Fₙ is related to a current conducted by a corresponding LED. When the LEDs in the LED unit 160 are turned off, the feedback selecting unit 130 selects the second feedback signal FS as the output. The driving unit 105 adjusts the driving power VOUT according to the second feedback signal FS. In other words, when the LED unit 160 is turned off, the driving unit 105 still maintains a magnitude of output current for conducting the LED unit 160.

The current pre-charging unit 150 may be viewed as a second output current path of the driving unit 105. When the LEDs in the LED unit 160 are temporarily turned off (i.e. when switched off by the enable signal EN), an output current of the driving unit 105 may be maintained by the current pre-charging unit 150, so as to prevent the output current from being lowered to zero. Accordingly, when the LEDs are again conducted, the driving unit 105 is capable of rapidly providing a large current to the LEDs, thereby preventing a delay in conducting the LEDs that may affect normal display. At this time, the current pre-charging unit 150 may coordinate with the conduction of the LEDs by temporarily shutting down, so as to lower current consumption. Then, according to the enable signal EN, a turn on time of the current pre-charging unit 150 may be determined.

Next, a circuit of the driving unit 105 is further illustrated in the following. Referring to FIG. 1B, FIG. 1B is a circuit diagram of the driving unit 105 in accordance with the first embodiment of the invention. The driving unit 105 includes a power converting unit 110, a pulse width modulating (PWM) unit 120, and a current adjusting unit 140. The power converting unit 110 is coupled to the LED unit 160 formed by a plurality of LED strings, and the power converting unit 110 is configured to convert an input voltage VIN to the driving voltage VOUT for the LED strings in the LED unit 160. The LED strings in the LED unit 160 are formed by a plurality of LEDs connected in series respectively. Another end of the LED strings respectively are coupled to the current adjusting unit 140. The current adjusting unit 140 has a capability to control a conducting current of each of the LED strings, and may control whether the LED strings are lighted or not according to the enable signal EN selectively conducting specific LED strings. The current pre-charging unit 150 is coupled to an output of the power converting unit 110, and the feedback selecting unit 130 is coupled to the current pre-charging unit 150 and the PWM unit 120. The feedback selecting unit 130 may receive the first feedback signals F₁-Fₙ returned from the current adjusting unit 140, and may receive the second feedback signal FS returned from the current pre-charging unit 150. The first feedback signals F1-Fn are voltage signals of the connecting ends of each of the LED strings and the current adjusting unit 140. The second feedback signal FS returned by the current pre-charging unit 150 changes according to a size of the current conducted.

The PWM unit 120 may adjust a PWM signal PWMS according to a feedback signal selected by the feedback selecting unit 130, so that the power converting unit 110 outputs a corresponding driving power VOUT. In another embodiment of the invention, the driving unit 105 may also employ a pulse frequency modulating unit to adjust the driving power VOUT. In other words, the pulse frequency modulating unit may be used to replace the PWM unit 120.

When the enable signal EN is enabled, the current adjusting unit 140 conducts and lights the LED strings. At this time the feedback selecting unit 130 selects one of the first feedback signals F₁-Fₙ corresponding to the conducted LED strings (e.g., a feedback signal having the lowest voltage at a specified connecting node), and outputs the selected one of the first feedback signals F₁-Fₙ to the PWM unit 120. The PWM unit 120 adjusts the output of the power converting unit 110 according to the feedback signal received, so that the LED strings have a sufficient driving current. When the enable signal EN is disabled, the current adjusting unit 140 turns off the LED strings. In other words, the current conducted by the LED strings is stopped. At this time, the feedback selecting unit 130 selects and outputs the second feedback signal FS to the PWM unit 120. The PWM unit 120 adjusts the output of the power converting unit 110 according to a feedback voltage received, so that an output current or an output voltage of the power converting unit 110 is maintained at a predetermined value.

In other words, the present embodiment adds a current path in the driving circuit of the LEDs, so that the power converting unit 110 may maintain an output current value, and therefore current output is not discontinued due to a conductive state of the LEDs. In the present embodiment of the invention, when the LEDs are turned off, the magnitude of the conducted current by the power converting unit 110 may be maintained by the current pre-charging unit 150 so that the power converting unit 110 continues to output current. Accordingly, when the enable signal EN is enabled and the power converting unit 110 may directly provide a required current for conducting the LEDs as long as the current pre-charging unit 150 discontinues conducting current, and therefore an issue of insufficient driving current is prevented. The magnitude of current conducted by the current pre-charging unit 150 may be determined according to a design requirement, so that the magnitude of the conducted current may be controlled by the feedback selecting unit 130 or by a direct setting. The invention is not limited to aforementioned methods of setting the magnitude of the conducted current. It is sufficient if the current pre-charging unit 150 can provide a current path for the power converting unit 110. Moreover, the current pre-charging unit 150 needs not to be continuously conducting. To save power, the current pre-charging unit 150 may be configured to conduct only before the LED is turned on so that the current driving capability is maintained.

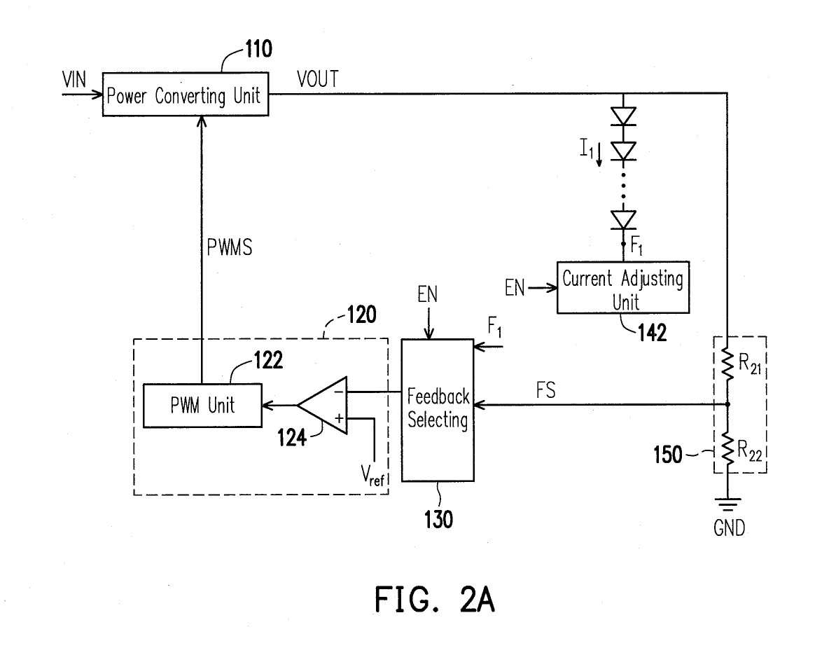

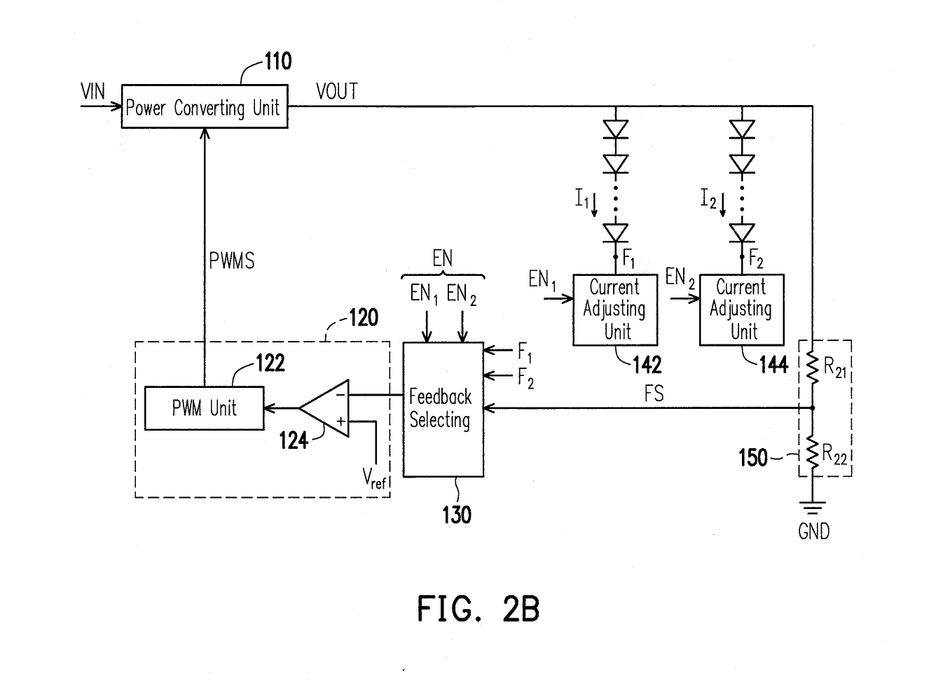

As shown in FIG. 2A, the current pre-charging unit 150 may be formed by serially coupled resistors. FIG. 2A is a detailed circuit diagram of a driving circuit in accordance with the first embodiment of the invention. As an illustrative example, the LED unit 160 is represented as a single LED string, and by setting a corresponding current controlling circuit 142 according to each specific LED string, the current adjusting unit 140 controls a magnitude of current conducted by the LED string. Taking FIG. 2A for example, the current controlling circuit 142 is coupled to an end of the LED string, and the current controlling circuit 142 generates a current I₁ according to the enable signal EN. A first feedback signal F₁ is generated by a node between the current controlling circuit 142 and the LED string. It should be noted that, according to a circuit design requirement, a metal-oxide-semiconductor (MOS) device may be disposed between the current controlling circuit 142 and the LED string to separate the current controlling circuit 142 and the LED string, and this does not affect the generation of the first feedback signal F₁.

The current controlling circuit 142 is formed by a structure including a current source and a current mirror, for example, although the invention is not limited thereto. The current pre-charging unit 150 includes a resistor R₂₁ and a resistor R₂₂ serially coupled between the driving power VOUT and a ground GND. The PWM unit 120 includes a PWM generator 122 and an operational amplifier 124. An input end of the operational amplifier 124 is coupled to an output of the feedback selecting unit 130 and a reference voltage V_{ref}, respectively. An output end of the operational amplifier 124 is coupled to the PWM generator 122.

When the enable signal EN is enabled, the LED string is in a normal display mode (i.e., a conducting mode), and the feedback selecting unit 130 selects the first feedback signal F₁ as the output. According to a voltage of the first feedback signal F₁, the PWM unit 120 determines whether a voltage and a current of the driving power VOUT are sufficient to drive the LED string, and outputs the PWM signal PWMS to the power converting unit 110. The power converting unit 110 is a boost circuit or a buck circuit, for example, that uses a duty cycle of the PWM signal PWMS to adjust a voltage value of the driving power VOUT. In conventional techniques, when the LED string is turned off, the power converting unit 110 lowers the voltage of the driving power VOUT to zero. Therefore, when the LED string is lit again, the power converting unit 110 cannot timely provide a large current to the LEDs. At this time, the LED string may have an issue of a turn-on delay or an inaccurate brightness. To mitigate this issue, the present embodiment adds a current pre-charging unit 150 in the driving circuit, thereby providing the power converting unit 110 another current path so as to maintain the current output of the power converting unit 110. When the LED string is conducting again, the required driving current may be rapidly supplied, and thereby a driving speed is accelerated.

When the LED string is turned off, the feedback selecting unit 130 switches a feedback path to the current pre-charging unit 150, so as to output the second feedback signal FS. According to the second feedback signal FS, the PWM unit 120 adjusts the duty cycle of the PWM signal PWMS, so as to adjust the output voltage of the power converting unit 110. According to a current I₁ when the LED string is turned on, the current pre-charging unit 150 may set resistance values of the resistors R₂₁ and R₂₂, so that the power converting unit 110 may output a corresponding current of a predetermined value when the LED string is turned off. Thereby, the power converting unit 110 may maintain a current driving ability thereof for conducting the LED string.

In the present embodiment of the invention, a number of LED strings driven by the power converting unit 110 is not limited. A plurality of LED strings may be driven by the power converting unit 110, and two LED strings are used in an illustrative example hereafter. Referring to FIG. 2B, FIG. 2B is a circuit diagram of a driving circuit in accordance with the first embodiment of the invention. The power converting unit 110 is configured to drive two LED strings, in which the LED strings are coupled between the output of the power converting unit 110 and the current controlling circuits 142 and 144. Nodes between the current controlling circuits 142 and 144 and the LED strings respectively output the first feedback signals F1 and F2 to the feedback selecting unit 130. Moreover, the enable signal EN is used to determine whether to conduct the LED strings. In the present embodiment of the invention, the enable signal EN may include a first enable signal EN1 and a second enable signal EN2, respectively configured to control the current controlling circuits 142 and 144.

Similarly, when the enable signal is enabled, the feedback selecting unit 130 returns one of the first feedback signals F₁-F₂ to the PWM unit 120. When the enable signal is disabled, the feedback selecting unit 130 returns the second feedback signal FS to the PWM unit 120. The PWM unit 120 adjusts the output of the power converting unit 110 according to the feedback signal received. As other parts of the circuit structure between FIGS. 2B and 2A are similar, and the further descriptions thereof are omitted hereinafter.

### Second Embodiment

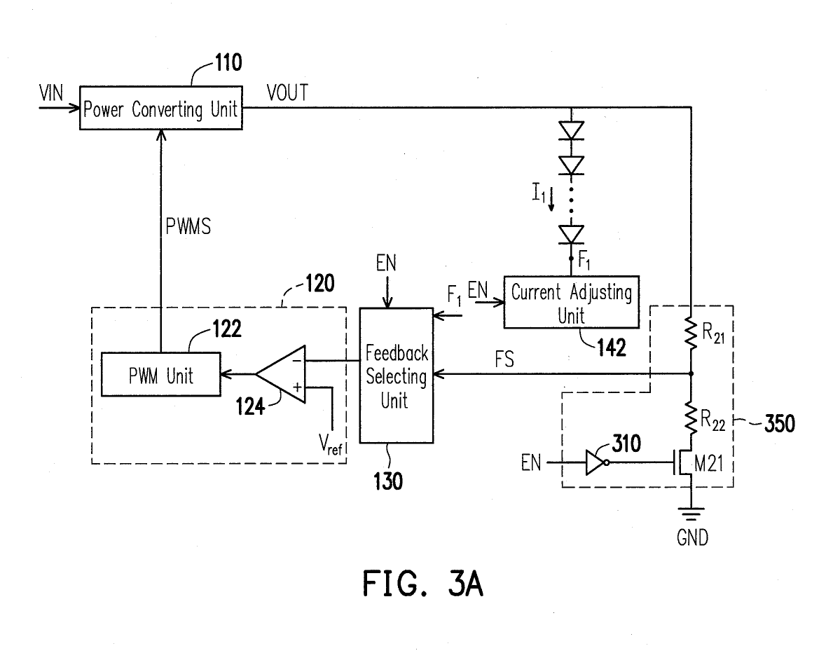

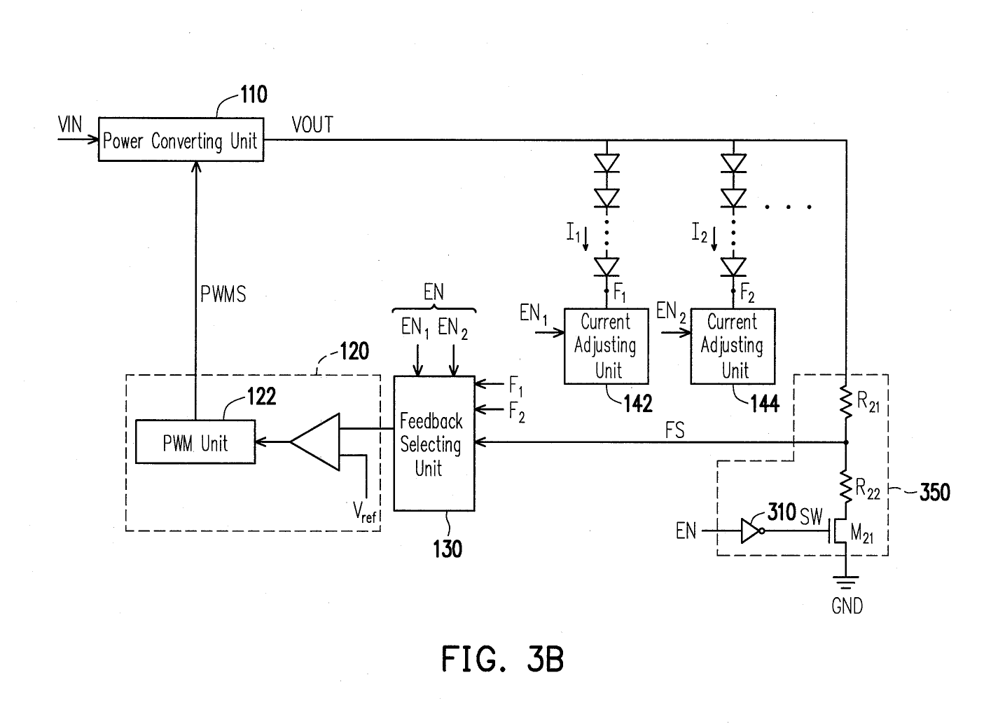

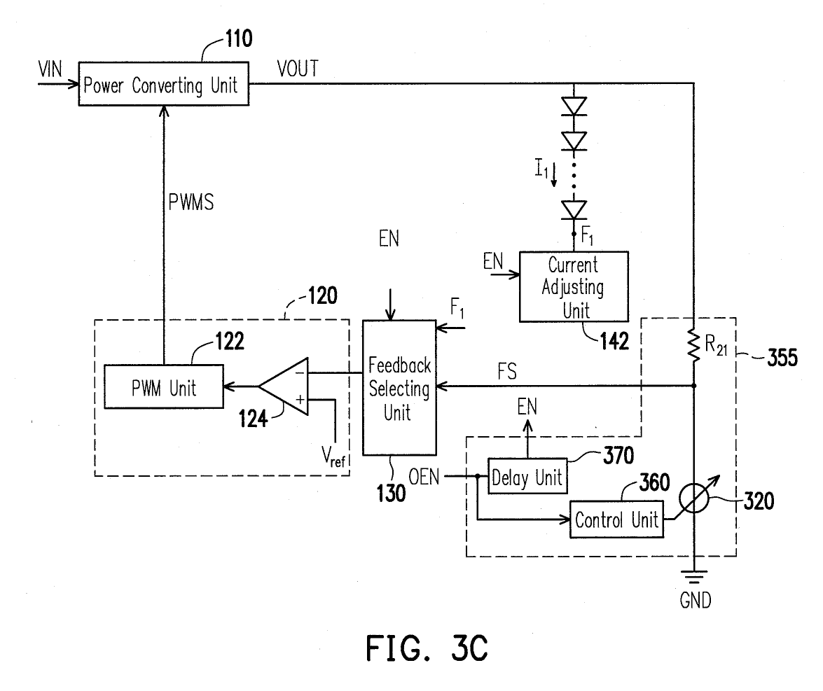

It should be noted that, as shown in FIG. 3A, a switch may be added in the above-described current pre-charging unit 150 (e.g., implemented by a NMOS transistor M₂₁) to conserve energy. FIG. 3A is a circuit diagram of a driving circuit in accordance with a second embodiment of the invention. A difference between FIGS. 3A and 2A lies in the NMOS transistor M₂₁. A current pre-charging unit 350 depicted in FIG. 3A includes resistors R₂₁ and R₂₂ along with the NMOS transistor M₂₁. The NMOS transistor M₂₁ is coupled between the transistor R₂₂ and the ground GND, and controlled by an inverted enable signal EN. The NMOS transistor M₂₁ may selectively conduct the current pre-charging unit 350. Moreover, when the LED strings need to be turned off for a period of time, or a display power is turned off, the current pre-charging unit 350 may turn off a current path to conserve power. During normal operation, when the enable signal EN is enabled, the NMOS transistor M₂₁ is turned off. When the enable signal EN is disabled, the NMOS transistor M₂₁ is turned on. Moreover, the NMOS transistor M₂₁ may be controlled by the feedback selecting unit 130 in accordance with the enable signal EN, or the NMOS transistor M₂₁ may be controlled by an independent control circuit such as an inverter 310, and the invention is not limited thereto. As other parts of the circuit structure between FIGS. 3A and 2A are similar, and the further descriptions thereof are omitted hereinafter.

Similarly, FIG. 3A may be adapted to drive a plurality of LED strings, as shown in FIG. 3B. FIG. 3B is a circuit diagram of a driving circuit in accordance with the second embodiment of the invention. FIG. 3B includes two LED strings, and FIGS. 2B and 3B may be referred to for a manner for driving the LED strings, and thus the further descriptions are omitted hereinafter.

### Third Embodiment

Next, referring to FIG. 3C, FIG. 3C is a circuit diagram of a driving circuit in accordance with a third embodiment of the invention. A difference between FIGS. 3C and 3A lies in a current pre-charging unit 355. The current pre-charging unit 355 includes the resistor R₂₁, an adjustable current source 320, a control unit 360, and a delay unit 370. The resistor R₂₁ and the adjustable current source 320 are coupled between the driving power VOUT and the ground GND. A node between the resistor R₂₁ and the adjustable current source 320 outputs the second feedback signal FS. The control unit 360 is coupled between an original enable signal OEN and the adjustable current source 320. According to the original enable signal OEN, the control unit 360 adjusts a current conducted by the adjustable current source 320. The delay unit is coupled between the feedback selecting unit 130 and the current controlling circuit 142. The delay unit 370 is configured to delay the original enable signal OEN, so as to generate the enable signal EN for the feedback selecting unit 130 and the current controlling circuit 142. During a delayed predetermined time of the original enable signal OEN, the control signal 360 adjusts beforehand the adjustable current source 320 in accordance with a magnitude of current to be conducted by the LED strings, so that the output current of the power converting unit 110 is increased in advance. After the predetermined time, the control unit 360 disables the adjustable current source 320, so that current originally conducted by the current pre-charging unit 355 is directed to the LED strings which are designated to turn on. Likewise, the current pre-charging unit 355 may be configured in FIG. 3B to replace the current pre-charging unit 350.

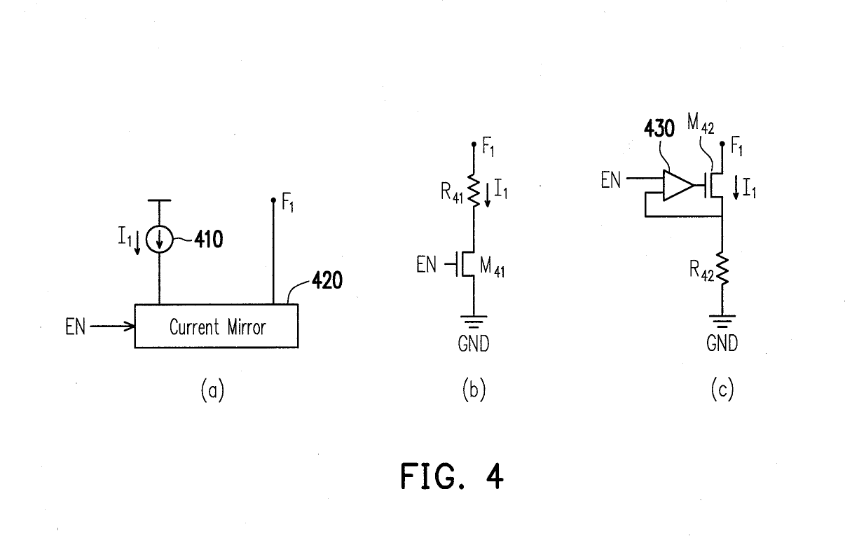

The above-described current controlling circuits 142 and 144 are configured to control a conducted current of an LED string. According to a design requirement, there may be a plurality of circuit structures for implementing the current controlling circuits 142 and 144, for example as shown in FIG. 4. FIG. 4 illustrates a plurality of circuit structures of a current controlling circuit in accordance with an embodiment of the invention. Taking the current controlling circuit 142 as an example and referring to FIGS. 4(a)-4(c), in FIG. 4(a) the current controlling circuit 142 may be formed by a current source 410 and a current mirror 420, configured to determine a current conducted by a LED string. It should be noted that, whether the current mirror 420 is enabled is controlled by the enable signal EN, and an exemplary implementation thereof may be a switch disposed in a current conducting path of the current mirror 420.

In FIG. 4(b), to implement the current controlling circuit 142, a resistor R₄₁ is connected in series with a NMOS transistor M₄₁ between the first feedback signal F1 and the ground GND. The NMOS transistor M₄₁ is controlled by the enable signal EN, and a size of a current conducted by the NMOS transistor M₄₁ may be determined by a voltage of the enable signal EN. In FIG. 4(c), the current controlling circuit 142 may be formed by an operational amplifier 430, a NMOS transistor M₄₂, and a resistor R₄₂. The input ends of the operational amplifier 430 is respectively coupled to the enable signal EN and a source of the NMOS transistor M₄₂. The resistor R₄₂ is coupled between the source of the NMOS transistor M₄₂ and the ground GND. It should be noted that, the circuit structures in the above-described FIG. 4 are merely exemplary embodiments of the circuit controlling circuit 142, and the invention is not limited thereto.

The current pre-charging unit 150 is configured to provide the power converting unit 110 another current path, and the current pre-charging unit 150 is adapted to maintain the output current of the power converting unit 110 when the LEDs are turned off. Moreover, in another embodiment of the invention, when the LEDs are about to be lit, the current pre-charging unit 150 may dynamically adjust the output current of the power converting unit 110 according to a corresponding magnitude of current of the enable signal EN, so that the LEDs may receive the needed current in time. For example, when the enable signal EN is about to conduct a current I₁ needed by a LED string, the current pre-charging unit 150 increases the output current of the power converting unit 110 by the current I₁. When the enable signal EN is about to conduct a current two times I₁ needed by a LED string, the current pre-charging unit 150 increases the output current of the power converting unit 110 by two times the current I₁. In other words, the current pre-charging unit 150 dynamically adjusts the magnitude of current conducted according to the enable signal EN, so that the output current of the power converting unit 150 may perform adjustments in advance according to the enable signal EN.

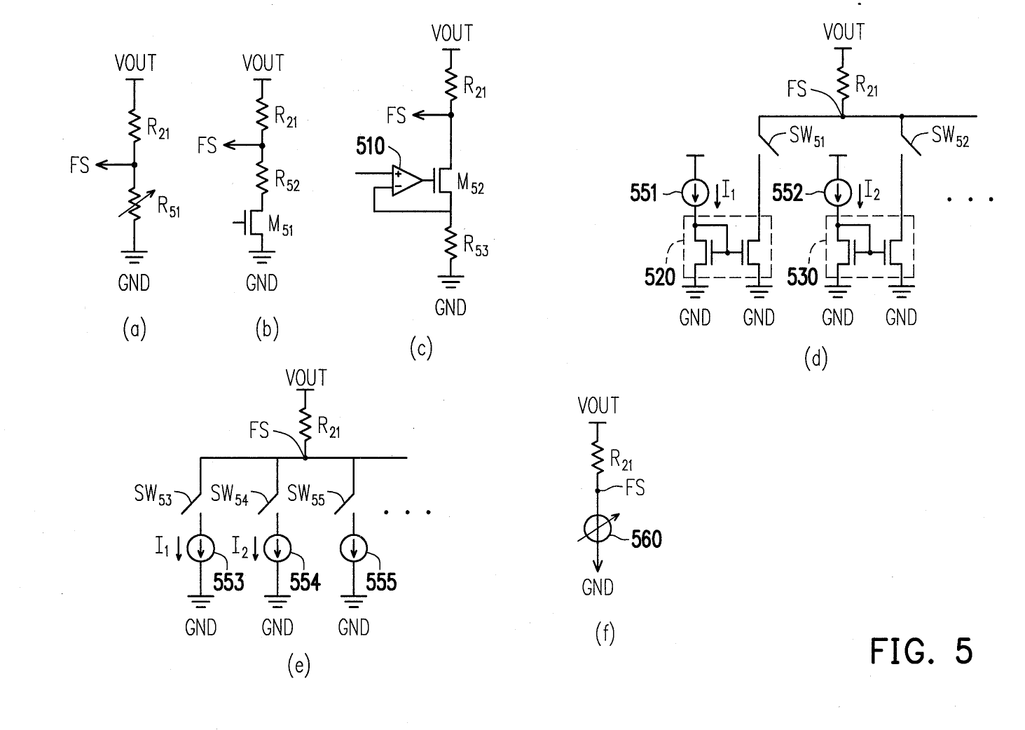

The adjustable current source 320 in the current pre-charging unit 355 may be implemented by various circuit structures according to a design requirement, for example as shown in FIG. 5. FIG. 5 illustrates a plurality of circuit structures of a current pre-charging unit in accordance with an embodiment of the invention. Referring to FIG. 5(a), in the current pre-charging unit 150, a resistor R₂₁ and an adjustable resistor R₅₁ are connected in series between the driving power VOUT and the ground GND. By adjusting a resistance value of the adjustable resistor R₅₁, the current pre-charging unit 150 may adjust the output current of the power converting unit 110. In another embodiment of the invention, the adjustable resistor R51 may be directly adjusted by using the feedback selecting unit 130 according to the enable signal EN to adjust the output current of the power converting unit 110.

Next, referring to FIG. 5(b), a difference between FIGS. 5(a) and 5(b) lies in a NMOS transistor M₅₁ coupled between a resistor R₅₂ and the ground. A gate of the NMOS transistor M51 is coupled to the control unit 360. When the driving circuit enters an energy saving mode, a current path of the current pre-charging unit 355 may be turned off to conserve power consumption. FIG. 5(c) illustrates a circuit structure for a constant current, including a resistor R₂₁, a NMOS transistor M₅₂, an operational amplifier 510, and a resistor R₅₃. The resistor R₂₁, the NMOS transistor M₅₂, and the resistor R₅₃ are coupled between the driving power VOUT and the ground GND. A negative input end of the operational amplifier 510 is coupled to a source of the NMOS transistor M₅₂. A current conducted by the current pre-charging unit 355 may be controlled through a positive input end of the operational amplifier 510.

Referring to FIG. 5(d), FIG. 5(d) is formed by a resistor R₂₁ and a plurality of current mirrors 520 and 530. The resistor R₂₁ is connected to the current mirrors 520 and 530 through a switch SW₅₁ and a switch SW₅₂, respectively. The current mirrors 520 and 530 respectively mirror a current I₁ and a current I₂ from a current source 551 and a current source 552. By controlling whether the switches SW₅₁ and SW₅₂ are turned on, the current flowing through the resistor R₂₁ may be adjusted. The switches SW₅₁ and SW₅₂ may also be controlled by the control unit 360. The current mirrors 520 and 530 depicted in FIG. 5(d) may be directly integrated with a current source in the current adjusting unit 140, so as to mirror the conducted currents of each of the LED strings. The current mirrors 520 and 530 may adopt a typical current mirror design, and the width to length ratios of transistors used in the current mirrors 520 and 530 may be based upon a current ratio, thus no further description is provided hereinafter. Moreover, as shown in FIG. 5(e), the above-described current mirrors 520 and 530 depicted in FIG. 5(d) may be directly represented as current sources. In FIG. 5(e), a resistor R₂₁ is coupled to a current source 553, a current source 554, and a current source 555 through a switch SW₅₃, a switch SW₅₄, and a switch SW₅₅, respectively. By controlling whether the switches SW₅₃, SW₅₄, and SW₅₅ are turned on, the current flowing through the resistor R₂₁ may be adjusted. Likewise, the switches SW₅₃, SW₅₄, and SW₅₅ may also be controlled by the feedback selecting unit 130.

As described above in FIGS. 5(a)-5(e), the circuit structure of the current pre-charging unit 150 may be formed by a resistor and an adjustable current source, as shown in FIG. 5(f). In FIG. 5(f), a resistor R₂₁ and an adjustable current source 560 are connected in series between the driving power VOUT and the ground GND. For the circuit structure of the adjustable current source 560, please refer to the implementations illustrated in the aforementioned FIGS. 5(a)-5(e), although the invention is not limited thereto. The current magnitude of the adjustable current source 560 may be adjusted according to the enable signal EN or design requirement, so that the current magnitude of the adjustable current source 560 may be set at a predetermined value, so as to maintain the magnitude of output current from the power converting unit 110.

In light of the foregoing, an embodiment of the invention adds a current pre-charging unit (e.g., 150, 350, or 355) at the output end of the power converting unit 110. This current pre-charging unit may be enabled in advance of the LEDs being conducted, so that the output current of the power converting unit 110 is raised beforehand to increase a driving capability thereof. When the LEDs are turned on, this current path is automatically turned off, thereby allowing the LEDs to rapidly receive a required magnitude of current. In a dynamic display process, the current pre-charging unit may coordinate with the adjustable current source to delay the enable signal of the LEDs a period of time. In this delay time period, the output current of the power converting unit 110 is raised in advance. When the LEDs are turned on, a current path is automatically turned off, so as to allow the LEDs to obtain the required current magnitude. By setting the current pre-charging unit, the output current of the power converting unit 110 may be adjusted beforehand, so that the LEDs may be rapidly turned on.

Moreover, the above-described current adjusting unit 140 and the current pre-charging units 150, 350, and 355 are configured to control a current magnitude, and to generate feedback signals for adjusting the output of the power converting unit 110. The circuit structures depicted in the above-described FIGS. 4 and 5 serve only as exemplary embodiments of the current adjusting unit 140 and the current pre-charging unit 150, and thus the invention is not limited thereto. Persons of ordinary skill in the art may easily derive other feasible circuit structures by referring to the disclosure of the invention, and details are not further described hereinafter. The NMOS transistor depicted in FIGS. 4 and 5 may be implemented as a PMOS transistor, with corresponding adjustments to the circuit structure.

### Fourth Embodiment

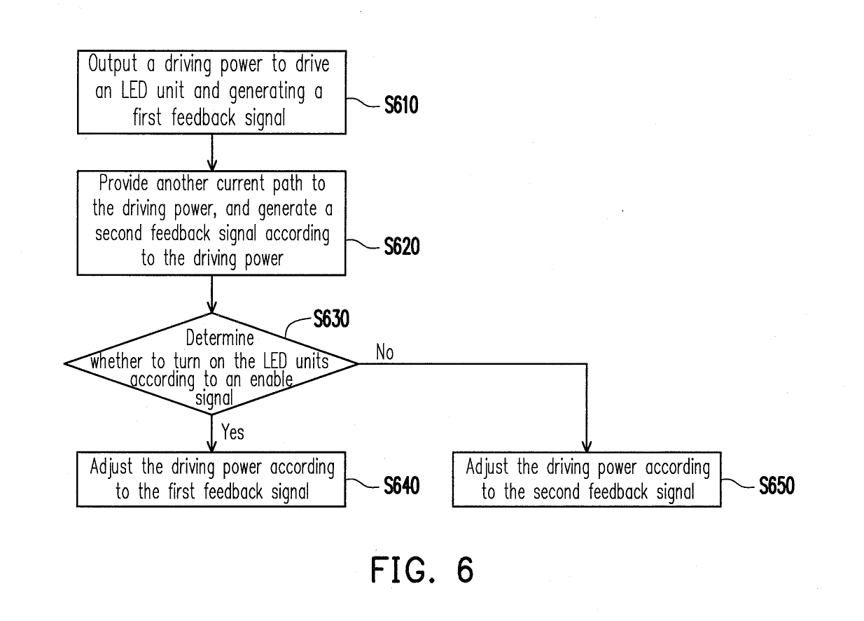

From another perspective, a driving method of an LED may be generalized from the aforementioned embodiment, as illustrated in FIG. 6. FIG. 6 is a flow chart of a driving method in accordance with a fourth embodiment of the invention. The driving power is outputted to drive an LED unit and generate a first feedback signal (Step S610). In this step, the first feedback signal is used to adjust a voltage and a current of the driving power, so that the LED unit receives a sufficient driving current. Another current path is provided to the driving power, and according to a current conducted by this current path, a second feedback signal is generated (Step S620). In a driving process of the LED unit, the enable signal determines whether to turn on the LEDs in the LED unit (Step S630). When the LEDs in the LED unit are turned on, the driving power is adjusted according to the first feedback signal (Step S640), and when the LED unit is turned off, the driving power is adjusted according to the second feedback signal (Step S650). Since the driving power is adjusted in accordance with the second feedback signal when the LED unit is turned off, therefore the driving power may be adjusted by modifying the current conducted by the above-described current path, so that a sufficient current driving capability is provided in advance.

The aforementioned driving method provides an extra current path in the driving circuit of the LEDs. By adjusting a current magnitude of the driving power through this current path, the current driving capability of the driving power may match a current requirement for conducting the LEDs, so that a switching speed of the LEDs is accelerated. Please refer to the foregoing description of FIGS. 1-5 for the remaining operating details of the driving method. Thus, a detailed description thereof is omitted.

In light of the foregoing, an embodiment of the invention provides a method to enhance a driving capability of an LED driving circuit, in which an extra current path is disposed in the driving circuit for maintaining a current output capability thereof. Alternatively, according to a current magnitude required for conducting an LED string, an output current of the driving circuit may be adjusted in advance, so that the LEDs may be switched rapidly to receive the required driving current.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving circuit adapted to drive at least a light emitting diode (LED) unit, the LED unit comprising at least an LED, the driving circuit comprising:
a driving unit outputting a driving power to the LED unit, and outputting at least a first feedback signal in accordance with a current conducted by the LED unit;
a current pre-charging unit coupled to an output of the driving unit, providing a current path to the driving unit and generating a second feedback signal in accordance with the driving power; and
a feedback selecting unit coupled to the driving unit and the current pre-charging unit, selecting as an output one of the first feedback signals or the second feedback signal in accordance with an enable signal;
wherein, the driving unit adjusts the driving power in accordance with the output of the feedback selecting unit.

2. The driving circuit as claimed in claim 1, wherein the driving unit comprises:
a power converting unit coupled to the LED unit, converting an input voltage to the driving power, and outputting the driving power to the LED unit;
a current adjusting unit coupled to the LED unit, selectively turning on the LEDs in the LED unit and generating the first feedback signals in accordance with the enable signal; and
a pulse width modulating (PWM) unit coupled to the feedback selecting unit and the power converting unit, adjusting an output of the power converting unit in accordance with the output of the feedback selecting unit.

3. The driving circuit as claimed in claim 1, wherein when the enable signal is disabled so that the LED unit is turned off, the feedback selecting unit selects the second feedback signal as the output, so that an output current of the driving unit is maintained at a predetermined value.

4. The driving circuit as claimed in claim 1, wherein when the enable signal is enabled so that the LED unit is turned on, the feedback selecting unit selects one of the first feedback signals as the output.

5. The driving circuit as claimed in claim 2, wherein the LEDs in the LED unit are serially coupled to form at least an LED string, the LED strings being coupled between the output of the power converting unit and the current adjusting unit, and nodes between the LED strings and the current adjusting unit generates the first feedback signals.

6. The driving circuit as claimed in claim 5, wherein when the enable signal is enabled so that the current adjusting unit selectively turns on the LED strings, the feedback selecting unit selects one of the first feedback signals corresponding to the turned on LED as the output.

7. The driving circuit as claimed in claim 6, wherein the feedback selecting unit selects among the first feedback signals corresponding to the turned on LED strings a one having the smallest voltage as the output.

8. The driving circuit as claimed in claim 1, wherein the current pre-charging unit comprises:
a first resistor; and
a second resistor;
wherein, the first resistor and the second resistor are serially coupled between the output of the driving unit and a ground, and a node between the first resistor and the second resistor generates the second feedback signal.

9. The driving circuit as claimed in claim 1, wherein the current pre-charging unit comprises:
a first resistor;
a second resistor serially coupled with the first resistor between the output of the driving unit and a switch, another end of the switch coupled to the ground, and a node between the first resistor and the second resistor generates the second feedback signal; and
an inverter having an input end coupled to the enable signal, and an output end coupled to the switch;
wherein, when the enable signal is disabled, the switch is turned on; when the enable signal is enabled, the switch is turned off.

10. The driving circuit as claimed in claim 1, wherein the current pre-charging unit comprises:
a first resistor having an end coupled to the output of the driving unit; and
an adjustable current source coupled between another end of the first resistor and a ground;
a control unit coupled to the adjustable current source, adjusting a conducted current of the adjustable current source in accordance with an original enable signal; and
a delay unit coupled between the feedback selecting unit, a current controlling circuit of the driving unit, and the original enable signal, the delay unit delaying the original enable signal for a predetermined time so as to output the enable signal to the feedback selecting unit and the current controlling circuit;
wherein, a node between the adjustable current source and the first resistor outputs the second feedback signal, and during the predetermined time, the control unit changes a current conducted by the adjustable current source in accordance with the original enable signal.

11. The driving circuit as claimed in claim 10, wherein the control unit disables the adjustable current source after the predetermined time.

12. The driving circuit as claimed in claim 10, wherein the adjustable current source comprises:
at least a current mirror circuit coupled to the first resistor through a plurality of switches, selectively mirroring a current corresponding to the LEDs when turned on, in accordance with the original enable signal.

13. The driving circuit as claimed in claim 10, wherein the adjustable current source comprises:
an operational amplifier having a positive input end coupled to a reference voltage outputted by the control unit;
a NMOS transistor having a drain coupled to another end of the first resistor, a source coupled to a negative input end of the operational amplifier, and a gate coupled to an output end of the operational amplifier; and
a second resistor coupled between the source of the NMOS transistor and the ground.

14. The driving circuit as claimed in claim 10, wherein the adjustable current source comprises:
a plurality of switches coupled between the first resistor and a plurality of current sources, wherein the switches are controlled by the control unit.

15. The driving circuit as claimed in claim 2, wherein the power converting unit is a boost circuit.

16. The driving circuit as claimed in claim 2, wherein the current adjusting unit comprises a plurality of current adjusting circuits respectively coupled to the LEDs and respectively controlling the conducted currents of the LEDs in accordance with the enable signal.

17. A driving method of an LED, comprising:
outputting a driving power to drive an LED unit and generating at least a first feedback signal;
providing a current path to the driving power and generating a second feedback signal in accordance with a current conducted by the current path; and
determining whether to turn on the LEDs in accordance with an enable signal;
wherein, when the LED unit is turned off, the driving power is adjusted in accordance with the second feedback signal; when the LED unit is turned on, the driving power is adjusted in accordance with the first feedback signals.

18. The driving method as claimed in claim 17, further comprising adjusting a current of the driving power in accordance with the second feedback signal, when the LED unit is turned off, so as to maintain the current of the driving power at a predetermined value.

19. The driving method as claimed in claim 17, wherein the step of determining whether to turn on the LEDs in accordance with the enable signal further comprises:
receiving an original enable signal;
delaying the original enable signal a predetermined time so as to generate the enable signal; and
adjusting the current conducted by the current path in accordance with the original enable signal, during the predetermined time.

20. The driving method as claimed in claim 18, wherein the LED unit comprises at least an LED string.
